(19) United States
(12) Patent Application Publication
(10) Pub. No.: US 2024/0303286 A1
(43) Pub. Date: Sep. 12, 2024

(54) CONTENT OUTPUT APPARATUS, CONTROL METHOD OF CONTENT OUTPUT APPARATUS, AND RECORDING MEDIUM

(71) Applicant: HONDA MOTOR CO., LTD., Tokyo (JP)

(72) Inventor: Koji Tohmiya, Tokyo (JP)

(21) Appl. No.: 18/434,316

(22) Filed: Feb. 6, 2024

(30) Foreign Application Priority Data
Mar. 6, 2023 (JP) 2023-033540

(51) Int. Cl. G06F 16/9535; G06V 20/59

(52) U.S. Cl. CPC G06F 16/9535; G06V 20/593

(57) ABSTRACT

A content output apparatus includes: a content output section configured to output content through an output device located in a mobile body, the content being distributed by a content distribution service; a passenger determination section configured to determine a number of passengers located in the mobile body; and a content change section configured to change the content to be output by the content output section on a basis of whether the number of the passengers determined by the passenger determination section is one, or more than one.

### INCORPORATION BY REFERENCE

The present application claims priority under 35 U.S.C.§ 119 to Japanese Patent Application No. 2023-033540 filed on Mar. 6, 2023. The content of the application is incorporated herein by reference in its entirety.

### BACKGROUND OF THE INVENTION

### Field of the Invention

The present invention relates to a content output apparatus, a control method of the content output apparatus, and a recording medium.

### Description of the Related Art

In recent years, efforts are becoming increasingly active to provide access to sustainable transportation systems that are considerate also of people in vulnerable positions, such as older people, people with disabilities, and children, among traffic participants. To attain this, a focus is placed on research and development to further improve safety and convenience through development related to vehicle comfort. As technology related to comfort for mobile bodies such as vehicles and the like, a conventional technology is known that outputs content through an output apparatus within a mobile body (Japanese Patent Laid-Open No. 2014-003584, for example). This patent literature discloses a management system that causes a content distribution server to distribute various types of content to a content execution device, including a device for vehicles.

Japanese Patent Laid-Open No. 2014-003584, however, does not consider outputting different types of content in a vehicle on the basis of the number of passengers in the vehicle. This may result in, for example, outputting content that the driver of the vehicle does not want fellow passengers in the vehicle to see or hear, or revealing the driver's preferred types of content to the fellow passengers in the vehicle.

The present invention has been achieved in view of the circumstances described above and has an object of allowing content to be output in a mobile body on the basis of the number of passengers of the mobile body.

### SUMMARY OF THE INVENTION

One aspect of the present invention is a content output apparatus including: a content output section configured to output content through an output device located in a mobile body, the content being distributed by a content distribution service; a passenger determination section configured to determine a number of passengers located in the mobile body; and a content change section configured to change the content to be output by the content output section on a basis of whether the number of the passengers determined by the passenger determination section is one, or more than one.

According to an aspect of the present invention, content based on the number of passengers can be output in a mobile body.

### BRIEF DESCRIPTION OF THE DRAWINGS

FIG. 1 is a diagram showing a configuration of a content distribution system;

FIG. 2 is a diagram showing a configuration of a vehicle; and

FIG. 3 is a flowchart showing an operation of a content output apparatus.

### DETAILED DESCRIPTION OF THE PREFERRED EMBODIMENTS

### 1. Configuration of Content Distribution System

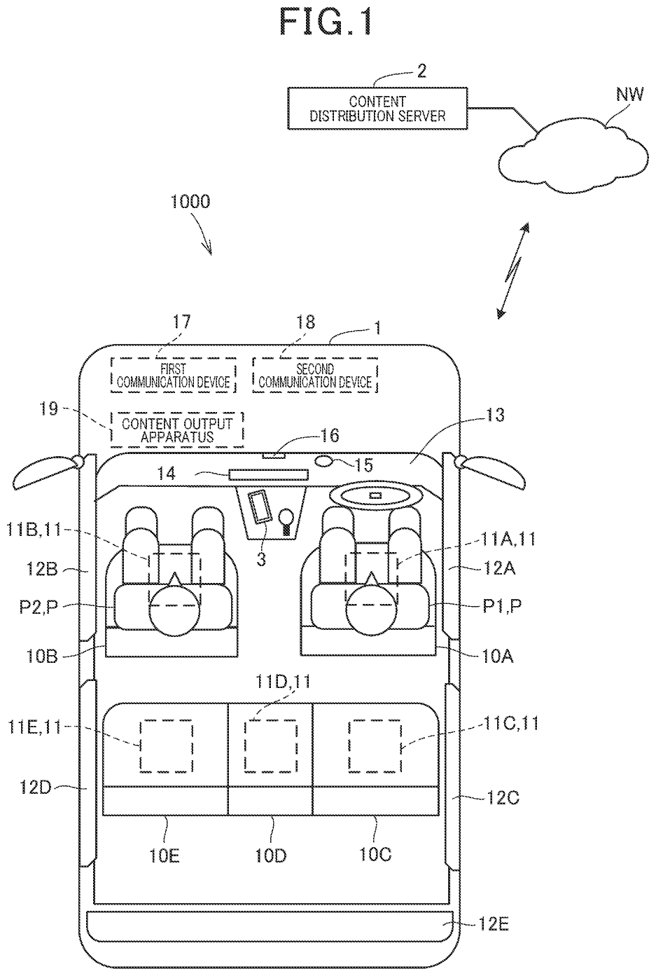

FIG. 1 is a diagram showing a configuration of a content distribution system 1000.

The content distribution system 1000 is a system that distributes content for passengers P located in a vehicle 1. Examples of content to be distributed by the content distribution system 1000 include a video, a still image, and music. In the present embodiment, a video including sound is illustrated as content distributed by the content distribution system 1000.

The vehicle 1 is an example of a “mobile body”.

The content distribution system 1000 includes the vehicle 1 and a content distribution server 2. The content distribution server 2 is a server device that provides a content distribution service for distributing content. The content distribution server 2 connects to a network NW to communicate with the vehicle 1. The network NW is a communication network that includes a public network, a dedicated line, and other communication circuits.

Content distributed by the content distribution server 2 may be different for different accounts used to log in to the content distribution service. In the present embodiment, the content distribution service is logged in to by using any of a first account, a second account, and a third account.

The first account is an account used by an owner of the vehicle 1, and it is an account that has no restriction on playable content items. Furthermore, the first account is an account that is associated with a history of content items played in the past, content items specified in the past for instant playback, and the like. When the first account is used to log in to the content distribution service, the content distribution server 2 includes, in its content distribution, content items played in the past, content items specified in the past, and the like.

The second account is not an account for use by a particular person. The second account is not associated with a history of content items played in the past, content items specified in the past for instant playback, or the like. The second account is an account equivalent to a newly created account. When the second account is used to log in to the content distribution service, the content distribution server 2 includes, in its content distribution, predetermined content items. That is, when the second account is used to log in to the content distribution service, as compared to when the first account is used, the content distribution server 2 cannot automatically include, in its content distribution, content items played in the past, content items specified in the past, or the like.

The third account is an account having a parental lock set for the third account. A parental lock is a function to restrict content a child can see or hear, and it is a function that requires input of an identification number to give access to content having an age limit. When the third account is used to log in to the content distribution service, the content distribution server 2 includes, in its content distribution, content items other than those having an age limit on access.

### 2. Configuration of Vehicle

The vehicle 1 illustrated in FIG. 1 is a four-wheel vehicle with a riding capacity of five persons. The vehicle 1 includes a driver seat 10A, a front passenger seat 10B, a rear right seat 10C, a rear center seat 10D, and a rear left seat 10E. These five seats include respective seat sensors 11A, 11B, 11C, 11D, 11E, and 11F for detecting a weight given to the respective seats. In the vehicle 1 of FIG. 1, a driver P1 and a fellow passenger P2 are in the vehicle as passengers P of the vehicle 1. FIG. 1 illustrates a situation where the driver P1 is seated in the driver seat 10A and the fellow passenger P2 is seated in the front passenger seat 10B in the vehicle 1.

In the description below, when the seat sensors 11A, 11B, 11C, 11D, 11E, and 11F are not distinguished, a symbol 11 is used to indicate “seat sensors 11”.

The vehicle 1 includes a front right door 12A, a front left door 12B, a rear right door 12C, a rear left door 12D, and a tailgate 12E. Opening the front right door 12A, the front left door 12B, the rear right door 12C, or the rear left door 12D allows ingress to and/or egress from an interior space of the vehicle 1. The tailgate 12E opens or closes a trunk of the vehicle 1.

The vehicle 1 includes a dashboard 13. A touch panel 14 and a speaker 15 are disposed on the dashboard 13. The touch panel 14 includes a display panel and a touch sensor in an integrated or superimposed manner, the display panel being for displaying characters and images, the touch sensor being for detecting contact with the display panel. The speaker 15 outputs sound to the interior space of the vehicle 1. The position of the speaker 15 and the number of speakers 15 can be changed to any position and any number.

The touch panel 14 and the speaker 15 are examples of an “output device”.

A camera 16 for capturing an image inside of the interior of the vehicle 1 is disposed in the interior of the vehicle 1. A capturing range of the camera 16 is set to a range that can capture the driver P1 as well as passengers P in addition to the driver P1. A plurality of cameras 16 may be disposed in the interior of the vehicle 1.

The vehicle 1 includes: a first communication device 17 (transmitter/receiver, circuit) capable of communicating with a mobile key 3; and a second communication device 18 (transmitter/receiver, circuit) capable of communicating with the content distribution server 2 connected to the network NW. The mobile key 3 is a so-called FOB (Frequency Operated Button) key, or a portable terminal device that performs short-distance wireless communication, such as a smartphone.

The first communication device 17 includes a LF (LOW Frequency)/RF (Radio Frequency) antenna, a wireless communication circuit, and the like, and communicates with the mobile key 3 located within a range that allows communication with the first communication device 17. The second communication device 18 is a so-called TCU (Telematics Control Unit) and communicates with the content distribution server 2.

The vehicle 1 includes a content output apparatus 19. The content output apparatus 19 is an apparatus that outputs content through the touch panel 14 and the speaker 15, the content being distributed by the content distribution service.

### 3. Configuration of Content Output Apparatus

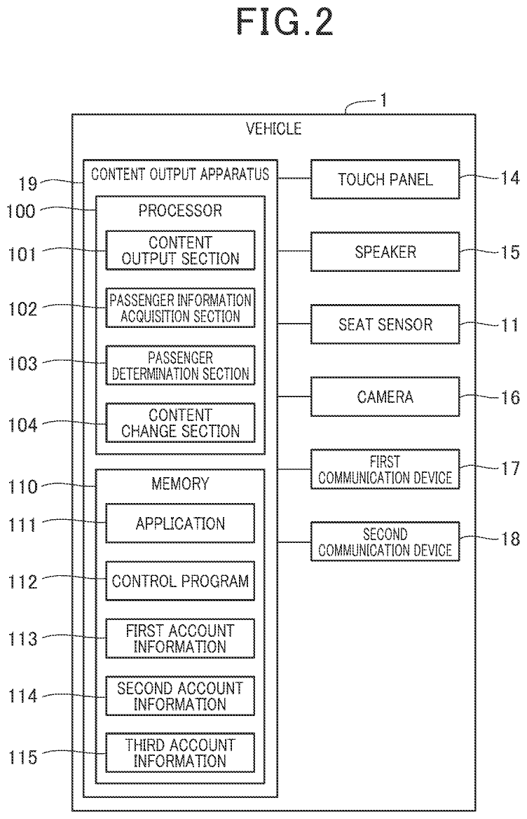

FIG. 2 is a diagram showing a configuration of the content output apparatus 19 included in the vehicle 1.

The content output apparatus 19 is connected to the touch panel 14, the speaker 15, the seat sensors 11A to 11E, the camera 16, the first communication device 17, and the second communication device 18. Devices connected to the content output apparatus 19 are not limited to these devices, and still other types of devices may also be connected to the content output apparatus 19.

The touch panel 14 displays various types of information in accordance with control of the content output apparatus 19.

The speaker 15 outputs various types of sound in accordance with control of the content output apparatus 19.

Each of the seat sensors 11 detects weight with a predetermined period and outputs a detection signal indicating the detected weight to the content output apparatus 19.

The camera 16 captures an image with a predetermined period and outputs image data for the captured image to the content output apparatus 19.

The first communication device 17 and the second communication device 18 communicate with the content output apparatus 19.

The content output apparatus 19 includes: a processor 100, such as a CPU (Central Processing Unit) and an MPU (Micro Processor Unit); a memory 110; and an interface circuit for connecting other devices and sensors.

The memory 110 is a storage device for storing a program and data. The memory 110 stores an application 111, a control program 112, first account information 113, second account information 114, third account information 115, and data to be processed by the processor 100. The memory 110 includes a nonvolatile storage area. The memory 110 may also include a volatile storage area to form a work area for the processor 100. The memory 110 is formed of, for example, a ROM (Read Only Memory) and a RAM (Random Access Memory).

The control program 112 is an example of a “program”.

The application 111 is an application program for using the content distribution service.

The first account information 113 is information for logging in to the content distribution service using the first account. The first account information 113 has recorded therein a combination of an ID (identification) and a password for use in login authentication, and information indicating that the type of account for use in login is the first account.

The second account information 114 is information for logging in to the content distribution service using the second account. The second account information 114 has recorded therein a combination of an ID and a password for use in login authentication, and information indicating that the type of account for use in login is the second account.

The third account information 115 is information for logging in to the content distribution service using the third account. The third account information 115 has recorded therein a combination of an ID and a password for use in login authentication, and information indicating that the type of account for use in login is the third account.

The first account information 113, the second account information 114, and the third account information 115 may have the same ID and password, or different IDs and passwords.

The processor 100 functions as the content output section 101 by reading and executing the application 111 stored in the memory 110.

The content output section 101 receives content from the content distribution server 2 through the second communication device 18 and outputs the received content through the touch panel 14 and the speaker 15.

Prior to outputting content, the content output section 101 logs in to the content distribution service using an account specified by a content change section 104, which is described below. The content output section 101 logs in to the content distribution service by transmitting login-required information to the content distribution server 2 through the second communication device 18. This login-required information has recorded therein the type of account specified by the content change section 104 and the combination of the ID and password.

When the content output section 101 has logged in to the content distribution service, the content output section 101 receives a content item in conformity with the account used for the login from the content distribution server 2.

As described above, when the first account is used to log in to the content distribution service, the content distribution server 2 includes, in its content distribution, content items played in the past, content items specified in the past, and the like. Thus, when the first account is used to log in to the content distribution service, the content output section 101 can include, in content items to be output, content items played in the past, content items specified in the past, and the like.

Furthermore, as described above, when the second account is used to log in to the content distribution service, the content distribution server 2 includes, in its content distribution, predetermined content items, but it cannot automatically include, in its content distribution, content items played in the past, content items specified in the past, or the like. Thus, when the second account is used to log in to the content distribution service, the content output section 101 cannot automatically include, in content items to be output, content items played in the past, content items specified in the past, or the like.

Furthermore, as described above, when the third account is used to log in to the content distribution service, the content distribution server 2 includes, in its content distribution, content items other than those having an age limit on access. Thus, when the third account is used to log in to the content distribution service, the content output section 101 cannot automatically include, in content items to be output, content items having an age limit on access.

The processor 100 functions as the passenger information acquisition section 102, the passenger determination section 103, and the content change section 104 by reading and executing the control program 112 stored in the memory 110.

The passenger information acquisition section 102 acquires passenger information that is information on a passenger P of the vehicle 1. The passenger information acquisition section 102 receives through the first communication device 17 identification information from the mobile key 3 located in a range that allows communication with the first communication device 17. The identification information is a key code for an electronic key stored in the mobile key 3. The passenger information acquisition section 102 acquires from the memory 110 the passenger information associated with the identification information received from the mobile key 3. The passenger information associated with this identification information indicates the owner of the vehicle 1.

The passenger determination section 103 determines the number of passengers P of the vehicle 1.

The passenger determination section 103 determines the number of passengers P on the basis of, for example, the number of seat sensors 11 that have detected a weight greater than or equal to a first threshold value. The first threshold value is a threshold value for determining whether a person is seated in a seat. The first threshold value is predetermined by testing, simulation, or the like performed in advance. If the seat sensor 11A is the only seat sensor 11 that has detected a weight greater than or equal to the first threshold value, the passenger determination section 103 determines that the number of passengers P is one. If the seat sensors 11A and 11B are the seat sensors 11 that have detected a weight greater than or equal to the first threshold value, the passenger determination section 103 determines that the number of passengers P is more than one.

In another example, the passenger determination section 103 determines the number of passengers P on the basis of an image captured by the camera 16. The passenger determination section 103 determines how many persons are present in the image captured by the camera 16 through pattern matching or the like. If the passenger determination section 103 determines that only one person is present in the captured image, it determines that the number of passengers P is one. If the passenger determination section 103 determines that more than one person is present in the captured image, it determines that the number of passengers P is more than one.

The passenger determination section 103 determines whether a child is included in the passengers P of the vehicle 1.

The passenger determination section 103 determines that a child is included in the passengers P, if, for example, there is a seat sensor 11 that has detected a weight smaller than or equal to a second threshold value and greater than or equal to the first threshold value. The second threshold value is a value greater than the first threshold value, and it is a threshold value for determining whether a person seated in a seat is a child. The second threshold value is predetermined by testing, simulation, or the like performed in advance.

In another example, the passenger determination section 103 determines whether a child is included in the passengers P on the basis of an image captured by the camera 16. The passenger determination section 103 determines the faces of the passengers P from the captured image by pattern matching. If a child's face is among the faces of the passengers P determined, the passenger determination section 103 determines that a child is included in the passengers P. If a child's face is not among the faces of the passengers P determined, the passenger determination section 103 determines that a child is not included in the passengers P. It is determined whether the face of a passenger P is that of a child on the basis of a shape of the face, a size of the face, the presence or absence of gray hair, the positions of the eyes and nose relative to the entire face, the length of a jaw, or the like.

The content change section 104 changes content items to be output by the content output section 101. The content change section 104 changes content items to be output by the content output section 101 by changing the account used to log in to the content distribution service.

As described above, when the first account is used for login, content items to be output by the content output section 101 include content items played in the past and content items specified in the past. Furthermore, as described above, when the second account is used for login, content items to be output by the content output section 101 do not include content items played in the past or content items specified in the past. Furthermore, as described above, when the third account is used for login, content items to be output by the content output section 101 do not include content items having an age limit on access.

In a manner as described above, the content change section 104 can change content items to be output by the content output section 101 by changing the account used to log in to the content distribution service.

### 4. Operation of Content Output Apparatus

Operation of the content output apparatus 19 is now described below.

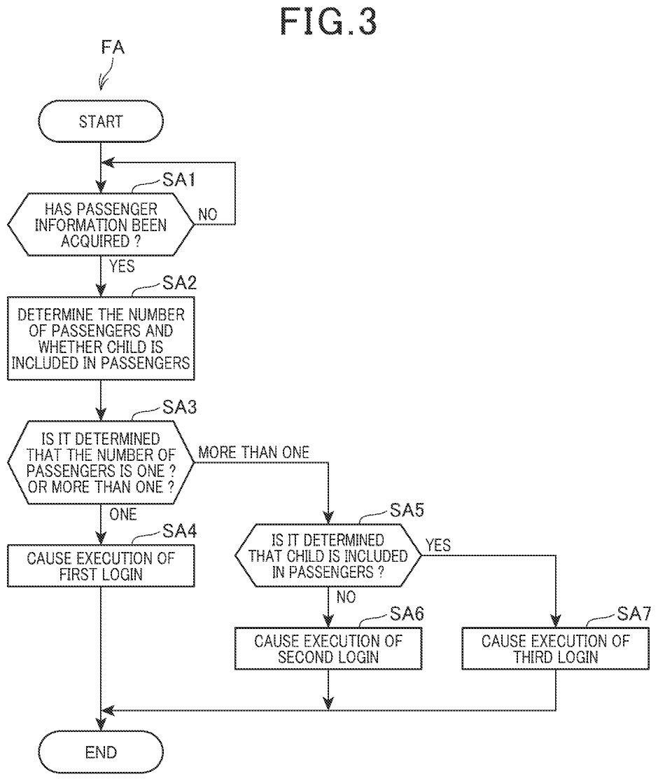

FIG. 3 is a flowchart FA showing an operation of the content output apparatus 19.

The passenger information acquisition section 102 determines whether passenger information has been acquired (step SA1).

If the passenger information acquisition section 102 determines that passenger information has not been acquired (step SA1: NO), the passenger information acquisition section 102 performs again the determination at step SA1.

If the passenger information acquisition section 102 determines that passenger information has been acquired (step SA1: YES), the passenger determination section 103 determines the number of passengers P and whether a child is included in the passengers P (step SA2).

Then, the content change section 104 determines whether the number of passengers P has been determined at step SA2 to be one, or more than one (step SA3).

If the content change section 104 determines that the number of passengers P has been determined to be one (step SA3: one), the content change section 104 causes the content output section 101 to execute first login (step SA4).

The first login is login to the content distribution service using the first account.

At step SA4, the content change section 104 reads the first account information 113 from the memory 110. Then, the content change section 104 outputs to the content output section 101 first required information for requesting the execution of the first login. The first required information includes: the ID and password recorded in the first account information 113 that has been read; and information indicating that the type of account for use in login is the first account. When the content output section 101 receives the first required information from the content change section 104, the content output section 101 executes the first login on the basis of the first required information. That is, the content output section 101 transmits to the content distribution server 2 the login-required information having recorded therein the ID and password recorded in the first required information and the type of account indicated by the first required information.

Reverting to description of step SA3, if the content change section 104 determines that the number of passengers P has been determined to be more than one (step SA3: more than one), the content change section 104 determines whether it has been determined at step SA2 that a child is included in the passengers P (step SA5).

If the content change section 104 determines that it has been determined that a child is not included in the passengers P (step SA5: NO), the content change section 104 causes the content output section 101 to execute second login (step SA6).

The second login is login to the content distribution service using the second account.

At step SA6, the content change section 104 reads the second account information 114 from the memory 110.

Then, the content change section 104 outputs to the content output section 101 second required information for requesting the execution of the second login. The second required information includes: the combination of the ID and password recorded in the second account information 114 that has been read; and information indicating that the type of account for use in login is the second account. When the content output section 101 receives the second required information from the content change section 104, the content output section 101 executes the second login on the basis of the second required information. That is, the content output section 101 transmits to the content distribution server 2 the login-required information having recorded therein the ID and password recorded in the second required information and the type of account indicated by the second required information.

Reverting to description of step SA5, if the content change section 104 determines that it has been determined that a child is included in the passengers P (step SA5: YES), the content change section 104 causes the content output section 101 to execute third login (step SA7).

The third login is login to the content distribution service using the third account.

At step SA7, the content change section 104 reads the third account information 115 from the memory 110. Then, the content change section 104 outputs to the content output section 101 third required information for requesting the execution of the third login. The third required information includes: the combination of the ID and password recorded in the third account information 115 that has been read; and information indicating that the type of account for use in login is the third account. When the content output section 101 receives the third required information from the content change section 104, the content output section 101 executes the third login on the basis of the third required information. That is, the content output section 101 transmits to the content distribution server 2 the login-required information having recorded therein the ID and password recorded in the third required information and the type of account indicated by the third required information.

### 5. Other Embodiments

The embodiment described above merely illustrates one aspect and can be changed or applied in any way.

In the embodiment described above, when the number of passengers P in the vehicle 1 is more than one, the second account is used to log in to the content distribution service. In another embodiment, when the number of passengers P in the vehicle 1 is more than one, the third account may be used to log in to the content distribution service. Alternatively, a fourth account may be used to log in to the content distribution service. The fourth account is an account having a restriction on the type of content to be distributed. The type of accessible content with the fourth account may be set manually or may be preset.

In the case of a configuration in which the fourth account is used for login, the memory 110 has fourth account information stored therein, instead of the second account information 114. The fourth account information is information for logging in to the content distribution service using the fourth account. The fourth account information has recorded therein a combination of an ID and a password for use in login authentication, and information indicating that the type of account for use in login is the fourth account. In the case of the configuration in which the fourth account is used for login, the content change section 104 reads the fourth account information from the memory 110 and causes the content output section 101 to use the fourth account for login on the basis of the fourth account information that has been read, in a similar manner to the first login, the second login, and the third login.

In the embodiment described above, the passenger information acquisition section 102 acquires passenger information on the basis of identification information stored in the mobile key 3. In another embodiment, the identity of the passenger P is input to the vehicle 1, and the information that has been input and indicates the identity of the passenger P is acquired as passenger information. This other embodiment is different from the embodiment described above in that a first account is an account used by a particular person. Thus, in this other embodiment, the memory 110 has stored therein a piece of first account information 113 for every person who may be input as a passenger P. In this other embodiment, when the identity of the passenger P is input through the touch panel 14, the passenger information acquisition section 102 acquires the information about the identity of the passenger P as the passenger information. Then, if the number of passengers P in the vehicle 1 is one, the content change section 104 reads from the memory 110 a piece of the first account information 113 corresponding to the passenger P indicated by the passenger information acquired by the passenger information acquisition section 102 and causes the content output section 101 to use a corresponding first account for login.

While a video accompanied by sound is illustrated as content in the embodiment described above, content may be a video not accompanied by sound, a still image accompanied by sound, a still image not accompanied by sound, or only sound. If content is other than a video accompanied by sound, the content output apparatus 19 outputs the content through at least any of the touch panel 14 and the speaker 15 in accordance with the data format of the content.

In the embodiment described above, the output device for displaying content is the touch panel 14 disposed on the dashboard 13. In another embodiment, the output device for displaying content is not limited to this touch panel 14 and may be any display disposed in the vehicle 1.

In the embodiment described above, the content output apparatus 19 does not include the touch panel 14. In another embodiment, the content output apparatus 19 may include the touch panel 14 and be configured as a device called display audio (DA) or as a car navigation device.

While the touch panel 14 and the speaker 15 are illustrated as the “output devices” in the embodiment described above, the “output device” is not limited to a device installed in the vehicle 1. In another embodiment, the “output device” may be a terminal device brought into the interior of the vehicle by a passenger P. Examples of the terminal device include a smartphone, and a PC (Personal Computer) such as a tablet terminal. In the case of this configuration, a terminal device as the “output device” is connected to the content output apparatus 19 by wire or wirelessly for communication, receives content from the content output apparatus 19, and outputs the received content from at least any of a display and a speaker installed in the terminal device.

In the embodiment described above, the vehicle 1 with four wheels is illustrated as the “mobile body.” The “mobile body,” however, is not limited to vehicles with four wheels and may be a vehicle with five wheels or more, or a vehicle with three wheels or fewer. Furthermore, the “mobile body” is not limited to land vehicles and may be a watercraft or an aircraft.

The processor 100 may be formed of a single processor or a plurality of processors. The processor 100 may be hardware programed to achieve the corresponding functional sections. That is, the processor 100 may be formed of, for example, an ASIC (Application Specific Integrated Circuit) or a FPGA (Field Programmable Gate Array).

Furthermore, the configuration of each of the sections in the vehicle 1 shown in FIG. 2 is an example, and their specific implementation is not particularly limited. That is, it is not necessary to implement hardware that separately corresponds to each of the sections, and it is of course possible to provide one processor that executes a program to achieve the functions of the sections. Furthermore, part of the functions implemented through software in the embodiment described above may be implemented through hardware, or part of the functions implemented through hardware may be implemented through software. Additionally, any change can be made to specific details of each of the sections of the vehicle 1.

Furthermore, the operation shown in FIG. 3 has been divided into step units in accordance with main processing to facilitate understanding of the operation, and the way processing units have been divided or their names do not limit the present invention. The operation may be divided into more step units in accordance with the processing. Furthermore, the operation may be divided such that one step unit includes more processing. Furthermore, the order of the steps may be changed as appropriate as long as no impediment is presented to the spirit of the present invention.

Furthermore, when the control method of the content output apparatus 19 described above is achieved using the processor 100, the program executed by the processor 100 can be implemented in the form of a recording medium or a transmission medium for transmitting the program. That is, the control program 112 can be provided as recorded in a portable information recording medium. Examples of the information recording medium include magnetic recording media such as a hard disk, optical recording media such as a CD, and semiconductor storage devices such as a USB (Universal Serial Bus) memory and a SSD (Solid State Drive), but other recording media can be also used.

### 6. Configurations Supported by the Foregoing Embodiments

The foregoing embodiments support the following configurations.

(First configuration) A content output apparatus including: a content output section configured to output content through an output device located in a mobile body, the content being distributed by a content distribution service; a passenger determination section configured to determine a number of passengers located in the mobile body; and a content change section configured to change the content to be output by the content output section on a basis of whether the number of the passengers determined by the passenger determination section is one, or more than one.

In accordance with the content output apparatus according to the first configuration, content to be output by the output device located in the mobile body can be changed on the basis of whether the number of passengers in the mobile body is one, or more than one. Thus, content based on the number of passengers can be output in the mobile body.

(Second configuration) The content output apparatus according to the first configuration, including a passenger information acquisition section configured to acquire passenger information, the passenger information being information on a passenger of the mobile body, wherein, when the passenger determination section determines that the number of the passengers is one, the content change section causes the content output section to log in to the content distribution service using a first account corresponding to the passenger information acquired by the passenger information acquisition section, so that the content to be output by the content output section is the content in conformity with the first account.

In accordance with the content output apparatus according to the second configuration, when the number of passengers in the mobile body is one, content to be output in the mobile body can be set to content preferred by the passenger. Thus, comfort in the mobile body when the number of passengers in the mobile body is one can be improved.

(Third configuration) The content output apparatus according to the first configuration or the second configuration, wherein, when the passenger determination section determines that the number of the passengers is more than one, the content change section causes the content output section to log in to the content distribution service using a second account having no history of the content played, so that the content to be output by the content output section is the content in conformity with the second account.

In accordance with the content output apparatus according to the third configuration, when the number of passengers in the mobile body is more than one, content to be output in the mobile body can be set to content in conformity with the second account having no history of content played. Thus, content preferences of a passenger can be inhibited from being revealed to another passenger.

(Fourth configuration) The content output apparatus according to the third configuration, wherein the passenger determination section determines whether a child is included in the passengers, and when the passenger determination section determines that a child is included in the passengers, the content change section causes the content output section to log in to the content distribution service using a third account having a parental lock set for the third account, so that the content to be output by the content output section is the content in conformity with the third account.

In accordance with the content output apparatus according to the fourth configuration, when a child is included in the passengers in the mobile body, content to be output in the mobile body can be set to content in conformity with the third account having a parental lock set for the third account. Thus, when a child is included in the passengers in the mobile body, content inappropriate for children can be inhibited from being output in the mobile body.

(Fifth configuration) The content output apparatus according to any one of the first configuration, the second configuration, and the fourth configuration, wherein, when the passenger determination section determines that the number of the passengers is more than one, the content change section causes the content output section to log in to the content distribution service using a fourth account having a restriction on a type of the content to be distributed, so that the content to be output by the content output section is the content in conformity with the fourth account.

In accordance with the content output apparatus according to the fifth configuration, when the number of passengers in the mobile body is more than one, content to be output in the mobile body can be set to content in conformity with the fourth account having a restriction on the type of content to be distributed. Thus, when the number of passengers in the mobile body is more than one, content not intended for other passengers can be inhibited from being output in the mobile body.

(Sixth configuration) The content output apparatus according to any one of the first configuration to the fifth configuration, wherein the passenger determination section determines the number of the passengers on a basis of an image captured by a camera disposed in the mobile body, or a detection signal of a seat sensor disposed on a seat in the mobile body.

In accordance with the content output apparatus according to the sixth configuration, the number of passengers in the mobile body can be determined accurately, and thus, content based on the number of passengers can be appropriately output in the mobile body.

(Seventh configuration) A control method of a content output apparatus, the method including: outputting content through an output device located in a mobile body, the content being distributed by a content distribution service; determining a number of passengers located in the mobile body; and changing the content to be output on a basis of whether the number of the passengers determined is one, or more than one.

In accordance with the control method of the content output apparatus according to the seventh configuration, effects similar to those of the content output apparatus according to the first configuration are achieved.

(Eighth configuration) A non-transitory computer readable recording medium recording a program configured to cause a processor of a content output apparatus that outputs, through an output device located in a mobile body, content distributed by a content distribution service, to function as: a passenger determination section that determines a number of passengers located in the mobile body; and a content change section that changes the content to be output by the content output apparatus on a basis of whether the number of the passengers determined by the passenger determination section is one, or more than one.

In accordance with the recording medium according to the eighth configuration, effects similar to those of the content output apparatus according to the first configuration are achieved.

### REFERENCE SIGNS LIST

1 vehicle (mobile body)
2 content distribution server
3 mobile key
11, 11A to 11E seat sensor
14 touch panel (output device)
15 speaker (output device)
16 camera
17 first communication device
18 second communication device
19 content output apparatus
100 processor
101 content output section
102 passenger information acquisition section
103 passenger determination section
104 content change section
110 memory
111 application
112 control program (program)
113 first account information
114 second account information
115 third account information
1000 content distribution system
P passenger
P1 driver
P2 fellow passenger

What is claimed is:

1. A content output apparatus comprising:
a content output section configured to output content through an output device located in a mobile body, the content being distributed by a content distribution service;
a passenger determination section configured to determine a number of passengers located in the mobile body; and
a content change section configured to change the content to be output by the content output section on a basis of whether the number of the passengers determined by the passenger determination section is one, or more than one.

2. The content output apparatus according to claim 1, comprising
a passenger information acquisition section configured to acquire passenger information, the passenger information being information on a passenger of the mobile body,
wherein, when the passenger determination section determines that the number of the passengers is one,
the content change section causes the content output section to log in to the content distribution service using a first account corresponding to the passenger information acquired by the passenger information acquisition section, so that the content to be output by the content output section is the content in conformity with the first account.

3. The content output apparatus according to claim 1,
wherein, when the passenger determination section determines that the number of the passengers is more than one,
the content change section causes the content output section to log in to the content distribution service using a second account having no history of the content played, so that the content to be output by the content output section is the content in conformity with the second account.

4. The content output apparatus according to claim 3,
wherein the passenger determination section determines whether a child is included in the passengers, and
when the passenger determination section determines that a child is included in the passengers,
the content change section causes the content output section to log in to the content distribution service using a third account having a parental lock set for the third account, so that the content to be output by the content output section is the content in conformity with the third account.

5. The content output apparatus according to claim 1,
wherein, when the passenger determination section determines that the number of the passengers is more than one,
the content change section causes the content output section to log in to the content distribution service using a fourth account having a restriction on a type of the content to be distributed, so that the content to be output by the content output section is the content in conformity with the fourth account.

6. The content output apparatus according to claim 1,
wherein the passenger determination section determines the number of the passengers on a basis of an image captured by a camera disposed in the mobile body, or a detection signal of a seat sensor disposed on a seat in the mobile body.

7. A control method of a content output apparatus, the method comprising:
outputting content through an output device located in a mobile body, the content being distributed by a content distribution service;
determining a number of passengers located in the mobile body; and
changing the content to be output on a basis of whether the number of the passengers determined is one, or more than one.

8. A non-transitory computer readable recording medium recording a program configured to cause a processor of a content output apparatus that outputs, through an output device located in a mobile body, content distributed by a content distribution service, to function as:
a passenger determination section that determines a number of passengers located in the mobile body; and
a content change section that changes the content to be output by the content output apparatus on a basis of whether the number of the passengers determined by the passenger determination section is one, or more than one.
